(19) United States
(12) Patent Application Publication
(10) Pub. No.: US 2008/0116812 A1
(43) Pub. Date: May 22, 2008

(54) Plasma display device and power supply thereof

(76) Inventor: Il-Woon Lee, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/888,538

(22) Filed: Jul. 31, 2007

(30) Foreign Application Priority Data
Nov. 20, 2006 (KR) 10-2006-0114690

(51) Int. Cl. G09G 3/12

(52) U.S. Cl. 315/169.4

(57) ABSTRACT

A plasma display device and its power supply are disclosed. The plasma display device includes driving circuit units for driving the display and a power supply for generating a plurality of power source voltages for the driving circuit units. The power supply includes a power supply unit with a first coil of a primary side of a transformer, converting an input voltage to a square wave for the first coil to provide power to second to the coils of the secondary side of the transformer.

### CROSS-REFERENCE TO RELATED APPLICATION

This application claims priority to and the benefit of Korean Patent Application No. 10-2006-0114690 filed in the Korean Intellectual Property Office on Nov. 20, 2006, the entire content of which is incorporated herein by reference.

### BACKGROUND

1. Field

The field relates to a plasma display device and its power supply. Description of the Related Technology

The plasma display device (PDP) is a flat panel display device for displaying characters or images by using plasma generated by a gas discharge, in which hundreds of thousands to millions of discharge cells are arranged in a matrix according to its size. A plasma display device can be categorized into either a DC type plasma display device or an AC type plasma display device depending on the driving voltage waveforms and structure of the discharge cells.

In a DC type PDP, electrodes are exposed to a discharge space, so current flows through the discharge space while voltage is being applied. Resistors must be formed on the panel to limit the current. In an AC type PDP, electrodes are covered by a dielectric layer, naturally forming a capacitor which limits current and protects the electrodes from impact of ions during discharge. Accordingly, the life span is relatively long compared to the DC type PDP.

The PDP includes a power supply for providing various high voltages, e.g., a sustain discharge voltage Vs, an address voltage Va, a reset voltage Vset, and a scan voltage, etc. to driving circuits, and low voltages to other circuit units, for example, an image processing unit, a fan, an audio unit, and a control circuit unit, etc.

FIG. 1 shows a power supply of a generalized PDP.

As shown in FIG. 1, the power supply includes a bridge diode 30 for rectifying an AC voltage input through an AC input filter 20 connected with an AC power source terminal 10 and converting it into a DC voltage; a power factor correction (PFC) circuit 40 for controlling a power factor of the DC voltage input from the bridge diode 30, and a plurality of DC-DC converters 50 for converting the DC voltage input from the PFC circuit 40 into a plurality of DC voltages to provide various voltages.

The DC-DC converter 50 includes a plurality of transformers 51, 52, and 53, and converters 54 and 55. The transformers 51, 52, and 53 convert the DC voltage input from the PFC circuit 40 and output it, respectively, and the output voltage or a voltage obtained by re-converting the output voltage by using the converters 54 and 55 are used to drive a plasma display panel.

However, because the power supply includes multiple transformers 51, 52, and 53 and many other circuit elements for them, it is difficult to implement in a reduced package size since transformers are inherently bulky components. In addition, many magnetic elements are required for implementing the transformers 51, 52, and 53, and much heat arises within the power supply when it is driven, so a large-volume heatsink needs to be used. This, too, presents an obstacle for making the PDP compact and reducing its cost.

The above information is for enhancement of understanding the general technology of PDPs.

### SUMMARY OF CERTAIN INVENTIVE ASPECTS

One aspect is a plasma display device including a plurality of first electrodes, a plurality of second electrodes, a plurality of third electrodes formed to cross the first and second electrodes, first, second, and third driving circuit units configured to respectively drive the first, second and third electrodes, and a power supply configured to generate a plurality of voltages for the driving circuit units. The power supply includes a power supply unit including a first coil of a primary side of a transformer and an input converter configured to convert an input voltage to a square wave for the first coil, and a plurality of output units configured to output a plurality of first power source voltages. Each output unit includes an additional coil on a secondary side of the transformer, the additional coil coupled to the first coil through the transformer, and at least one of the output units further includes a converter configured to convert the corresponding first power source voltage to output a plurality of second power source voltages.

Another aspect is a power supply configured to generate a plurality of voltages for driving a plurality of first electrodes, a plurality of second electrodes, and a plurality of third electrodes formed to cross the first and second electrodes, in a plasma display device. The power supply includes a power supply unit including a first coil of a primary side of a transformer and an input converter configured to convert an input voltage to a square wave for the first coil. The power supply also includes a plurality of output units configured to output a plurality of first power source voltages, each output unit including an additional coil of a secondary side of the transformer, the additional coil coupled to the first coil through the transformer, where at least one of the output units further includes a converter configured to convert the corresponding first power source voltage to output a plurality of second power source voltages.

### BRIEF DESCRIPTION OF THE DRAWINGS

FIG. 1 is a block diagram showing a power supply of a general plasma display device.

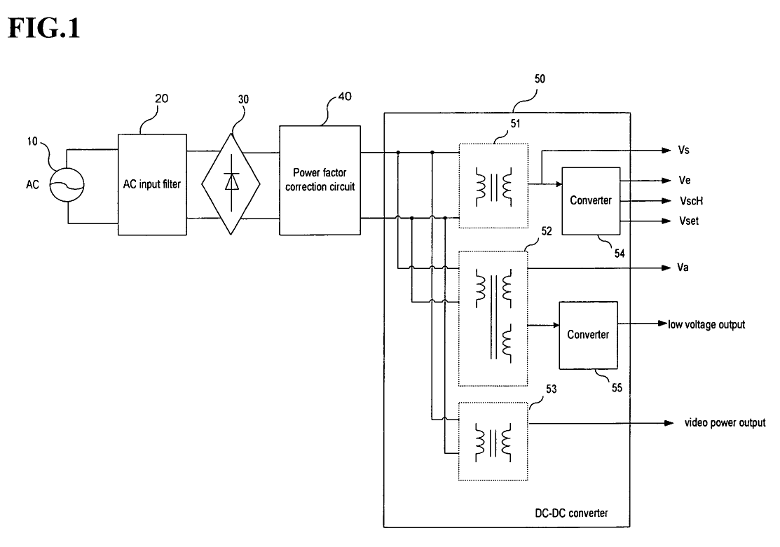

FIG. 2 is a block diagram showing a plasma display device according to an embodiment.

FIG. 3 is a block diagram illustrating a DC-DC converter according to an embodiment.

FIG. 4 is a timing diagram showing changes in output voltages of an output unit according to a transistor of a switching controller in one embodiment.

### DETAILED DESCRIPTION OF CERTAIN INVENTIVE EMBODIMENTS

Certain embodiments of a plasma display device and its power supply have advantages of minimizing implementation cost and size.

In the following detailed description, only certain embodiments have been shown and described, simply by way of illustration. As those skilled in the art would realize, the described embodiments may be modified in various ways, without departing from the spirit or scope of the present invention. Accordingly, the drawings and description are to be regarded as illustrative in nature and not restrictive.

Throughout this specification and the claims that follow, when it is described that an element is coupled to another element, the element may be directly coupled to the other element or electrically coupled to the other element through a third element.

The plasma display device and its power supply according to an embodiment will now be described in detail with reference to the accompanying drawings.

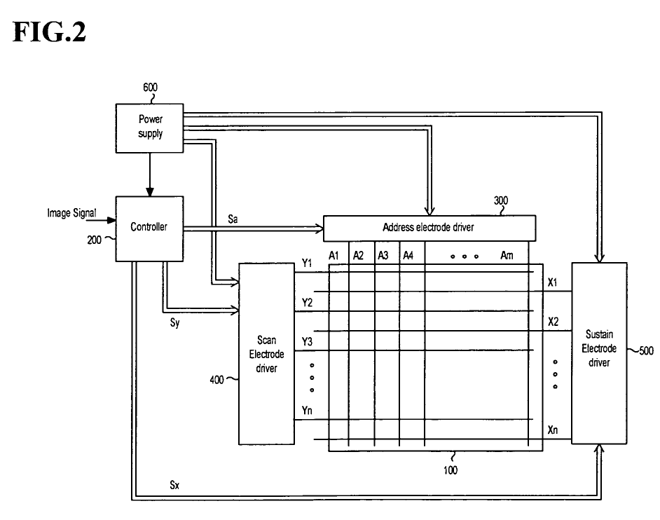

FIG. 2 is a block diagram showing a plasma display device according to the embodiment.

As shown in FIG. 2, the plasma display device includes a plasma display panel (PDP) 100, a controller 200, an address electrode driver 300, a scan electrode driver 400, a sustain electrode driver 500, and a power supply 600.

The PDP 100 includes a plurality of address electrodes A1˜Am extending in a column direction and a plurality of sustain electrodes X1˜Xn and scan electrodes Y1˜Yn extending in a row direction. The sustain electrodes X1˜Xn are formed corresponding to the scan electrodes Y1˜Yn. The PDP 100 includes a substrate (not shown) on which the sustain electrodes X1˜Xn and the scan electrodes Y1˜Yn are arranged and a substrate (not shown) on which the address electrodes A1˜Am are arranged. The two substrates are disposed to face each other with a discharge space therebetween such that the scan electrodes Y1˜Yn and the address electrodes A1˜Am and the sustain electrodes X1˜Xn and the address electrodes A1˜Am cross each other. In this case, a discharge space present at each crossing of the address electrodes A1˜Am, the sustain electrodes X1˜Xn, and the scan electrodes Y1˜Yn forms a discharge cell. The PDP 100 shows one example, and a panel with a different structure to which driving waveforms described hereinbelow can be applied can be also applicable.

The controller 200 receives a video signal and outputs an address electrode drive control signal Sa, a sustain electrode drive control signal Sx, and a scan electrode drive control signal Sy. The controller 200 drives the PDP by dividing a single frame into a plurality of sub-fields. Each field includes a reset period, an address period, and a sustain period in terms of a temporal operation. The controller 200 generates a scan high voltage (Vscan_h) to be applied to a cell which is not addressed during the address period by using a DC voltage received from the power supply 600, and transfers it to the scan electrode driver 400 or the sustain electrode driver 500.

The address electrode driver 300 receives the address electrode drive control signal Sa from the controller 200 and applies a display data signal for selecting discharge cells to be displayed to each address electrode.

The scan electrode driver 400 receives the scan electrode drive control signal Sy from the controller 200 and applies a driving voltage to the scan electrodes Y1˜Yn.

The sustain electrode driver 500 receives the sustain electrode drive control signal Sx from the controller 200 and applies a driving voltage to the sustain electrodes X1˜Xn.

The power supply 600 supplies power for driving the plasma display device to the controller 200 and the drivers 300, 400, and 500.

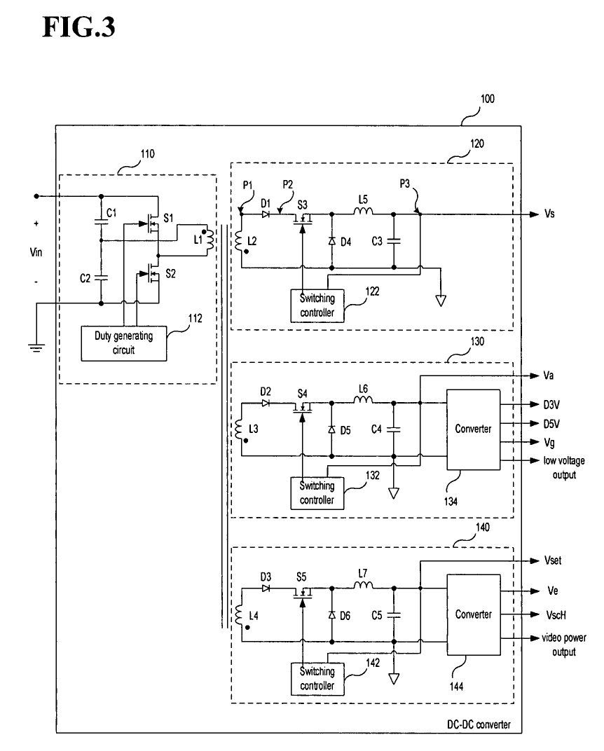

A DC-DC converter included in the power supply 600 in FIG. 2 will now be described with reference to FIG. 3.

FIG. 3 is a block diagram illustrating a DC-DC converter according to one embodiment.

As shown in FIG. 3, the DC-DC converter 100 includes a power supply unit 110, and a plurality of output units 120, 130, and 140.

The power supply unit 110 includes a capacitor C1 having one end connected with a DC voltage input terminal to which a voltage Vin, a DC voltage, provided from a power factor correction (PFC) circuit (not shown) is input. The power supply unit 110 also has a capacitor C2 with one end connected with the capacitor C1 and the other end connected with a ground terminal, a transistor S1 having a drain connected with one end of the capacitor C1, a transistor S2 having a drain connected with a source of the transistor S1 and a source connected with the other end of the capacitor C2, an inductor L1 having one end connected with a contact of the capacitors C1 and C2 and the other end connected with a contact of the transistors S1 and S2, and a duty generating circuit 112.

In this embodiment, the capacitors C1 and C2 have the same capacitance. Thus, a half of the voltage Vin, namely, Vin/2, is charged in the capacitors C1 and C2, respectively.

The duty generating unit 112 supplies a control signal for controlling driving of the transistors S1 and S2 to control electrodes of the transistors S1 and S2. The two transistors S1 and S2 are alternately driven to be turned on and off at the same duty ratio.

The output unit 120 may be implemented, for example, with a buck type converter which includes an inductor L2 having one end connected with a ground terminal and forming a transformer together with the inductor L1 of the power supply unit 110, a diode D1 having an anode connected with the other end of the inductor L2, a transistor S3 having a drain connected with a cathode of the diode D1, a diode D4 having a cathode connected with a source of the transistor S3 and an anode connected with one end of the inductor L1, an inductor L5 having one end connected with a cathode of the diode D4 and the other end connected with an output terminal, a capacitor C3 having one end connected with the other end of the inductor L5 and the other end connected with a ground terminal, and a switching controller 122.

In this embodiment, the switching controller 122 senses voltage of the output terminal and turns on or off the transistor S3 according to a result obtained by comparing the sensed voltage of the output terminal with a reference voltage Vref. Thus, output unit 120 stably outputs a reset voltage Vs through the output terminal. The reset voltage Vs is applied to the capacitor C3.

The output unit 130 is similar to the output unit 120, and outputs an output voltage of a buck type converter, namely, voltage charged in a capacitor C4, as an address voltage Va. Output unit 130 also generates various voltages D3V, D5V, Vg, and a low voltage, etc. by using a converter 134 which receives the voltage charged in the capacitor C4 as input.

The output unit 140 has a similar structure to that of the output unit 130. It outputs voltages Vset, Ve, VscH, and image power.

The output units 120, 130, and 140 can be implemented by using converters other than the buck type converters.

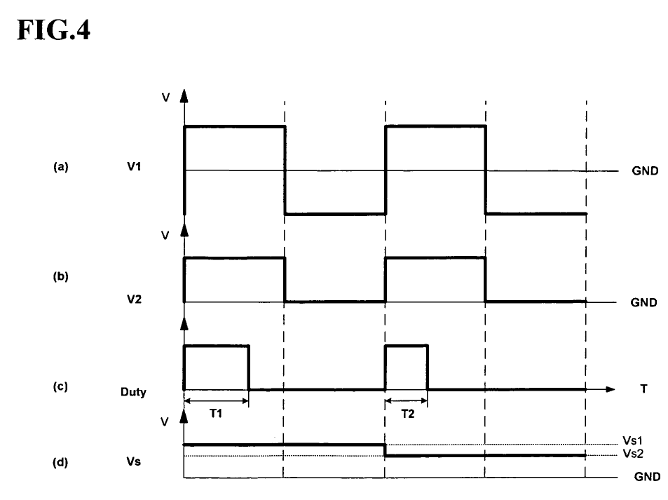

Changes in output voltages according to the controlling of the transistor S3 of the switching controller 122 included in the output unit 120 of the DC-DC converter 100 will now be described with reference to FIG. 4.

FIG. 4 is a timing diagram showing changes in output voltages of the output unit 130 according to the controlling of the transistor S3 of the switching controller 122.

FIG. 4(a) illustrates a waveform of a voltage V1, namely, voltage applied to a point P1.

The duty generating circuit 112 alternately drives signals to turn on or off the transistors S1 and S2. When the transistor S1 is turned on and the transistor S2 is turned off under the control of the duty generating circuit, the voltage Vin+ is applied to one terminal of the inductor L1, and through the transformer, a positive voltage is generated as voltage V1 at point P1. Conversely, when the transistor S2 is turned on and the transistor S1 is turned off, the voltage Vin− is applied to the inductor L1, and through the transformer, a negative voltage is generated as voltage V1 at point P1. Accordingly, the Vin+ and the Vin− are alternately driven to one terminal of the inductor L1 and the voltage Vin/2 is constantly applied to the other terminal of the inductor L1.

Because the duty generating circuit 112 alternately drives the transistors S1 and S2, the voltage V1 appears as a square wave alternating up and down relative to the ground as shown in FIG. 4(a).

FIG. 4(b) illustrates a waveform of a voltage V2 at a point P2.

The voltage V2 is obtained by rectifying the voltage V1 with the diode D1. Accordingly, only portions of the voltage V1 that have the positive value appear as shown in FIG. 4(b).

FIG. 4(c) indicates a duty signal applied from the switching controller 122 to the transistor S3, and FIG. 4(d) indicates the reset voltage Vs output through the output terminal of the output unit 120.

First, when the switching controller 122 sets the duty signal for determining time for sustaining an ON state of the transistor S3 as T1 and applies it, a voltage Vs1 is output as the reset voltage Vs. When the voltage Vs1 is higher than a reference voltage Vref, the switching controller 122 changes duty so as to be shorter than the duty signal T1 and applies the changed duty signal T2 to the transistor S3 to thus shorten time during which the transistor S3 is sustained in the ON state. Accordingly, the reset voltage Vs output to the output terminal is changed to the voltage Vs2, namely, a lower voltage corresponding to the shortened duty.

The DC-DC converter 100 is implemented as a single transformer, minimizing the cost. The reduction in the number of transformers leads to a reduction in the number of magnetic elements, decreasing an amount of heating, so it is not necessary to use the heatsink to thus considerably reduce the implementation area of the plasma display device.

While embodiments have been described in connection with what is presently considered to be practical, it is to be understood that the invention is not limited to the disclosed embodiments, but, on the contrary, is intended to cover various modifications and equivalent arrangements.

What is claimed is:

1. A plasma display device comprising:
a plurality of first electrodes, a plurality of second electrodes, and a plurality of third electrodes formed to cross the first and second electrodes;
first, second, and third driving circuit units configured to respectively drive the first, second and third electrodes; and
a power supply configured to generate a plurality of voltages for the driving circuit units, wherein the power supply comprises:
a power supply unit comprising a first coil of a primary side of a transformer and an input converter configured to convert an input voltage to a square wave for the first coil; and
a plurality of output units configured to output a plurality of first power source voltages, each output unit comprising an additional coil on a secondary side of the transformer, the additional coil coupled to the first coil through the transformer,
wherein at least one of the output units further comprises a converter configured to convert the corresponding first power source voltage to output a plurality of second power source voltages.

2. The device of claim 1, wherein the plurality of first power source voltages are each generated with a buck type converter in each of the output units.

3. The device of claim 2, wherein a first buck type converter included in a first output unit comprises:
a second coil having one end connected with a first power source for supplying an ‘M’ voltage;
a first diode having an anode connected with the second coil;
a first transistor connected with a cathode of the first diode;
a second diode having a cathode connected with the first transistor and an anode connected with the second coil;
an S coil connected with the cathode of the second diode; and
a first capacitor connected with the S coil and with the first power source.

4. The device of claim 3, wherein the first buck type converter further comprises:
a switching controller configured to compare a level of one of the plurality of first power source voltages with a reference voltage, and to turn on or off the first transistor.

5. The device of claim 4, wherein buck type converters are respectively included in each of the output units.

6. The device of claim 3, wherein the M voltage is a ground voltage.

7. The device of claim 3, wherein the cathode of the first diode is connected with a drain of the first transistor and the cathode of the second diode is connected with the source of the first transistor.

8. The device of claim 1, wherein the plurality of first power source voltages are different voltages.

9. The device of claim 1, wherein the plurality of second power source voltages are different voltages.

10. The device of claim 2, wherein the input voltage is a DC voltage output from a power factor correction (PFC) circuit.

11. A power supply configured to generate a plurality of voltages for driving a plurality of first electrodes, a plurality of second electrodes, and a plurality of third electrodes formed to cross the first and second electrodes, in a plasma display device, the power supply comprising:
a power supply unit including a first coil of a primary side of a transformer and an input converter configured to convert an input voltage to a square wave for the first coil; and
a plurality of output units configured to output a plurality of first power source voltages, each output unit comprising an additional coil of a secondary side of the transformer, the additional coil coupled to the first coil through the transformer,
wherein at least one of the output units further comprises a converter configured to convert the corresponding first power source voltage to output a plurality of second power source voltages.

12. The power supply of claim 11, wherein the plurality of first power source voltages are each generated with a buck type converter in each of the output units.

13. The power supply of claim 11, wherein the power supply unit comprises:
a first capacitor connected with a voltage input terminal;
a second capacitor connected with the first capacitor and connected with a first power source configured to supply an M voltage;
a first transistor connected with the first capacitor;
a second transistor connected with the first transistor and connected with the second capacitor; and
an S coil connected with the first and second capacitors and connected with the first and second transistors.

14. The power supply of claim 13, wherein the first and second capacitors have substantially the same capacitance.

15. The power supply of claim 13, wherein the power supply unit further comprises: a duty generating circuit configured to provide a control signal to control the first and second transistors.

16. The power supply of claim 13, wherein the duty generating circuit drives the first and second transistors according to the same duty.

17. The power supply of claim 13, wherein the M voltage is a ground voltage.

18. The power supply of claim 13, wherein the first capacitor is connected with a drain of the first transistor, and the second capacitor is connected with a source of the second transistor.

19. The power supply of claim 11, wherein the plurality of first power source voltages are different voltages.

20. The power supply of claim 11, wherein the plurality of second power source voltages are different voltages.
